(19) United States
(12) Patent Application Publication
(10) Pub. No.: US 2005/0111090 A1
(43) Pub. Date: May 26, 2005

(54) Incident light fluorescence stereo microscope

(75) Inventors: Lothar Kleinteich, Jena (DE); Johannes Winterot, Jena (DE); Johannes Knoblich, Jena (DE); Tobias Kaufhold, Jena (DE); Guenter Osten, Jena (DE)

Correspondence Address: Gerald H. Kiel, Esq.;REED SMITH LLP, 599 Lexington Avenue, New York, NY, 10022-7650, US

(73) Assignee: CARL ZEISS JENA GmbH

(21) Appl. No.: 10/993,905

(22) Filed: Nov. 19, 2004

(30) Foreign Application Priority Data
Nov. 21, 2003 (DE) 103 55 523.4

(51) Int. Cl. G02B 21/00; G02B 21/06

(52) U.S. Cl. 359/381; 359/368

(57) ABSTRACT

The invention is directed to a stereo microscope which is suitable particularly for observing fluorescence with incident light. Particularly advantageous fluorescence excitation is achieved when the illumination beam path has a zoom system by which an illumination is achieved that is adapted to the zoom factor of the observation beam path.

### CROSS-REFERENCE TO RELATED APPLICATION

This application claims priority of German Application No. 103 55 523.4, filed Nov. 21, 2004, the complete disclosure of which is hereby incorporated by reference.

### BACKGROUND OF THE INVENTION

a) Field of the Invention

The invention is directed to a stereo microscope which is suitable particularly for fluorescence observation with incident light.

b) Description of the Related Art

The use of fluorescence contrast in stereo microscopy has become increasingly important in recent years because of new goals for applications in biology, medicine, science and technology. One example of such applications is the use of the GFP (Green Fluorescent Protein) fluorochrome in microbiology.

Known equipment for fluorescence microscopy with stereo microscopes is based on different principles:

a) Equipment for External Oblique Incident Light Fluorescence Excitation with Lightguides and Focusing Attachments

Equipment for external, oblique incident light fluorescence excitation with focusing attachments are made available by the present applicant in the Stemi 1000/2000, SV6/SV11/SV11 Apo stereo microscopes. They are described in the Carl Zeiss information sheet “F1 S Equipment—Fluorescence Contrast with Stereo Microscopes” (40-510/9.97). An incident light fluorescence adapter SZX-FLUV is known from Olympus.

An embodiment example for external, oblique incident light fluorescence excitation in a stereo microscope is shown in FIG. 1. The lightguide 3, with attached displaceable focusing attachment 4, coming from a cold light source is held by a flexible cantilever holder 2 clamped to the pillar 1 of a stereo microscope next to the stereo microscope body 10 and objective 9. The angle of inclination of the excitation beam path 6 and the distance of the focusing attachment 4 from the object can be adjusted, depending on the free space available next to the microscope, by pressing the flexible cantilever holder 2. The focusing attachment 4 images the light spot of the light-conducting cable in the object plane. The image of the light spot 7 can be focused in the object plane by axial displacement of the focusing attachment 4. The respective excitation filter 5 is inserted into the focusing attachment 4. The associated blocking filter 12 is inserted in a filter intermediate tube 11 arranged after the objective 9 and microscope body 10 in the stereo microscope beam path 8 to observe the fluorescing object. The light shield, which can likewise be clamped to the pillar, and the cold light source are not shown in FIG. 1.

This external, oblique incident light fluorescence excitation with lightguides and focusing attachments has the following advantages: the intensity of the excitation can be optimized by displacing the focusing head on the light-guiding illumination part and by adjusting the distance of the illumination part from the object; the intensity of the excitation is high (illumination apertures are larger than the observation aperture); and hardly any interference light can reach the observation channel from the excitation beam path because the illumination channel and observation channel are spatially separated from one another.

This design has the following disadvantages: the light spot impinging in the object plane is elliptic to some extent, depending on the angle of inclination of the illumination, the distance of the focusing attachment from the object and the adjustment of the focusing attachment, and therefore has a drop in intensity in the longitudinal axis of the illumination; the light spot has a fixed size even when the magnification is changed at the stereo microscope zoom, and the illuminated object field is always more or less greater than the object field detected by the microscope and higher objective magnifications therefore have less image brightness; excitation light can be reflected toward the observer with back illumination; the excitation filter and blocking filter with different changing locations lie far apart from one another and must therefore be changed individually in a time-consuming manner (so that modular construction is impossible); and the holder with the illumination must be readjusted and optimized when changing the objectives or when changing the height of the adjusting plane.

b) Equipment for External, Oblique Incident Light Fluorescence Excitation with Ring Lamps

Equipment of this kind is known from the NIKON Fluorescence Ring Illuminator C-FPS and the MEIJI Fluorescent Ring Light MA 305.

An embodiment example of external, oblique incident light fluorescence excitation with ring lamps in a stereo microscope is shown in FIG. 2. The ring lamp 13 with lightguide 3 is attached to the objective 9 and generates the circular light spot 7 in the object plane with the excitation beam path converging obliquely at the radiating angle. The respective excitation filter 5 is inserted into the filter holder of a cold light source. The associated blocking filter 12 is inserted into a filter intermediate tube 11 arranged in the stereo microscope beam path 8 after the objective 9 and microscope body 10. The light shield which can be clamped to the pillar and the cold light source are also not shown in FIG. 2.

The external, oblique incident light fluorescence excitation with ring lamps has the following advantages: the light spot impinging in the object plane is circular; the illumination and light spot remain in the object plane when changing objectives or when changing the height of the adjusting plane; and hardly any interference light can reach the observation channel from the excitation beam path because the illumination channel and observation channel are spatially separated from one another.

It has the following disadvantages: the light spot has a fixed size even when the magnification is changed at the stereo microscope zoom, and the illuminated object field is always larger to some extent than the object field detected by the microscope and higher objective magnifications therefore have less image brightness; the light spot in the focused object plane is optimally illuminated only with certain objectives; the illumination intensity is low because the radiating direction of the ring lamp is more polydirectional; the excitation filter and blocking filter with different changing points lie far apart from one another and must therefore be changed individually in a time-consuming manner (here again, modular construction is not possible).

c) Coaxial Incident Light Fluorescence Excitation through both Channels of the Stereo Microscope

Equipment of this kind is the GFP Illuminator by Kramer Scientific Corporation, Elmsford, N.Y., USA, for the Carl Zeiss SV 6/SV stereo microscope, whose basic principle is described in U.S. Pat. No. 6,147,800.

An embodiment example of coaxial incident light fluorescence excitation through both channels of the stereo microscope is shown in FIG. 3. A fluorescent illuminator 16 is arranged between the microscope body 10 and the observing tube 15, wherein the illumination light 17 impinging laterally from the left-hand side through the excitation filter 5 strikes two dichroic mirrors 19 which deflect the excitation light 14 through the two zoom channels of the microscope body 10 and objective 9 to the circular light spot 7 in the object plane. The stereoscopic observation beam path 8 coming from the fluorescing object travels back via the objective 9 and microscope body 10 through the two dichroic mirrors 19 and the two blocking filters 12 arranged after the latter in the observing tube 15. The excitation filter 5, dichroic mirror 19 and blocking filter 12 are constructed as a slide module 20 which is equipped depending on the fluorescence analysis method and can be changed in the fluorescent illuminator 16. When changing the fluorescence modules, a shutter 18 coupled to the module holder is automatically switched on as a light shield.

This kind of incident light fluorescence excitation through both channels of the stereo microscope has the following advantages: the light spot impinging in the object plane is circular and is illuminated and observed at the stereo angle; the size of the light spot is determined by the respective zoom magnification and objective magnification; the optimally illuminated light spot always lies in the focused object plane and, therefore, it is possible to change the objective and to refocus at the microscope without manipulating the illumination; and the excitation filter, dichroic mirror and blocking filter lie close to one another so that they can easily be constructed as modules for a slide or filter wheel, which makes it possible to change the fluorescence modules quickly on a slide or filter wheel that has been loaded.

It is disadvantageous that the illumination is carried out through the observation channel and the illumination intensity is therefore determined by the zoom aperture; it can only be optimized by adjusting the lamp collector. The transmission of the optics, which are actually designed for stereoscopic observation, in the zoom channels has a disadvantageous result for the intensity of the fluorescence excitation in the UV range, and the excitation light can cause stray light in the zoom channels which worsens the image contrast.

d) Coaxial Incident Light Fluorescence Excitation through One Channel of the Stereo Microscope

Such devices as the LEICA fluorescence module for MS-MZ, Olympus Fluorescence Illuminator P-FLA and the Nikon SZX-RFL Fluorescence Illuminator are known.

FIG. 4 shows an embodiment example of a coaxial incident light fluorescence excitation of this type through one channel of the stereo microscope. A fluorescence illuminator 16 is arranged between the microscope body 10 and observing tube 15, wherein the illumination light 21 impinging from the back (i.e., from the side opposite to the user) in a stereo channel through the excitation filter 5 strikes a dichroic mirror 19 which deflects the excitation light 14 through one zoom channel of the microscope body 10 and objective 9 to the circular light spot 7 in the object plane. The stereoscopic observation beam path 8 coming from the fluorescing object travels back in both stereo channels through the objective 9 and microscope body 10 through the two dichroic mirrors 19 and the two blocking filters 12 following the latter into the observing tube 15. The excitation filter 5, dichroic mirrors 19 and blocking filter 12 are constructed as a slide module 20 which is equipped depending on the fluorescence analysis method and can be changed in the fluorescent illuminator 16. When changing the fluorescence modules, a shutter 18 coupled with the module holder switches on automatically as a light shield for the user.

This type of incident light fluorescence excitation through one channel of the stereo microscope has the following advantages: the light spot impinging in the object plane is circular; the size of the light spot is determined by the respective zoom magnification and objective magnification; the optimally illuminated light spot always lies in the focused object plane and therefore makes it possible to change the objective and to refocus at the microscope without manipulating the illumination; and the excitation filter, dichroic mirror and blocking filter lie close together so that they can easily be constructed as modules for slides or filter wheels, which makes it possible to change the fluorescence modules quickly on a slide or filter wheel that has been loaded.

It is disadvantageous that the illumination is carried out on one side through the one observation channel at the stereo angle and that the illumination intensity is determined by the zoom aperture; it can only be optimized by adjusting the lamp collector. The transmission of the optics, which are actually designed for stereoscopic observation, in the zoom channels has a disadvantageous effect on for the intensity of the fluorescence excitation in the UV range, and the excitation light can cause stray light in the excitation channel and worsen the image contrast, so that the image is brighter in the excitation channel than in the pure observation channel. In the pure observation channel, arrangement of the blocking filter alone is sufficient for wavelength selection; when wavelength regions lie close together, the dichroic mirror matching the excitation is needed in addition to the blocking filter.

e) Integrated Incident Light (Fluorescence) Illumination through Two Illumination Channels Lying Outside of the Observation Channels of the Stereo Microscope

This kind of arrangement of illumination channels in a stereo microscope, preferably with two lightguides that are inclined somewhat relative to the optical axis is described in the German Laid Open Application DE 19822255 by the applicant.

An embodiment example of this illumination arrangement is shown in FIG. 5. A twin lightguide 22 coming from a cold light source is guided into the microscope body 10 and is divided therein into two individual fiber bundles 23 which, together with the associated focusing optics 24, form an illumination plane 25 lying orthogonal to the observation plane 27. The respective fluorescence excitation filter 5 is inserted in the filter holder of the cold light source and the light exiting from the individual fiber bundles 23 is deflected by the focusing optics 24 and the objective 9 as excitation beam path 26 to the circular light spot 7 in the object plane. The associated blocking filter 12 is inserted into a filter intermediate tube 11 arranged between the microscope body 10 and the observing tube 15 in the stereoscopic beam path 8 proceeding from the fluorescing object for observing the latter. The light shield which can be clamped to the pillar and the cold light source are not shown in FIG. 5.

This illumination arrangement has the following advantages: it is carried out with a minimal space requirement and the basic mechanical-optical construction is influenced only minimally; the maximum visible object field enables a bright, homogeneous and reflection-free illumination of the object regardless of the position and observation direction of the stereo microscope; the light spot impinging in the object plane is circular and always lies in the focused object plane and it is therefore possible to change the objective and to refocus at the microscope without manipulating the illumination; and the focusing optics of the lightguides can be also be constructed as zoom systems coupled to the observation zoom and the size of the light spot can accordingly be adapted to the respective zoom magnification and objective magnification.

It is disadvantageous that the excitation filter and blocking filter with different changing locations lie far apart from one another and must therefore be changed individually (modular construction is therefore impossible).

f) Integrated Coaxial Incident Light Fluorescence Excitation through a Third Channel which is Analogous to the Stereo Channels and which Lies Between the Normal Stereo Channels so as to be Offset with Respect to the Center

This arrangement of a third illumination channel which is analogous to the stereo channels and lie between the normal stereo channels so as to be offset with respect to the center is described in the protective application EP 1 010 030.

EP 1 010 030 describes a single-channel zoom body (magnification changer) and a two-channel (stereo) zoom body (likewise referred to as a magnification changer), each of which has another illumination beam path lying at least approximately parallel to the observation beam path.

FIG. 6 shows an embodiment example of the coaxial incident light fluorescence excitation through the third channel which is analogous to the two channels of the stereo microscope. A fluorescence illuminator 28 is fixedly connected to the microscope body 10 between the microscope body 10 and the observing tube 15. The illumination light 29 entering from the back is deflected by a stationary mirror 30 through the excitation filter 5 into the illumination channel 31 which guides the excitation light 32 through the microscope body 10 and objective 9 at an angle of inclination approximating the stereo angle from the front to the circular light spot 7 in the object plane. The stereoscopic observation beam path 8 proceeding from the fluorescing object travels back through the objective 9 and microscope body 10 through two blocking filters 12 in the observing tube 15. The excitation filters 5 and blocking filters 12 are constructed as module 33 which is equipped depending on the fluorescence analysis method and which can be changed or switched in the fluorescence illuminator 28. When changing the fluorescence modules, the illumination light 29 can be covered by switching on a shutter 34.

This illumination arrangement has the following advantages: the light spot impinging in the object plane is circular, its size is determined by the respective zoom magnification and objective magnification, and the optimally illuminated light spot always lies in the focused object plane so that it is possible to change the objective and to refocus at the microscope without manipulating the illumination device. The zoom optics in the separate illumination channel are optimized for better transparency to UV and blue light. Any possible autofluorescence does not interfere with observation: stray light or worsened image contrast are prevented. The excitation light is coupled into the third illumination channel in a simple manner, the dichroic splitter mirror is replaced by a reflection element, and the excitation filter and blocking filter which lie close together can be constructed as a flat module for slides or filter wheels making it possible to change the fluorescence modules quickly on a slide or filter wheel that has been loaded or equipped.

It is disadvantageous that the illumination intensity which is increased by a better transparency of the zoom optics to UV and blue light is still limited by the illumination aperture (corresponding to the respective observation aperture).

### OBJECT AND SUMMARY OF THE INVENTION

It is the primary object of the invention to overcome the disadvantages of the prior art and to provide an incident light fluorescence excitation with a high illumination aperture for all observation zoom magnifications that is greater than the aperture of the observation zoom itself.

This object is met by an incident light fluorescence stereo microscope comprising two eyepieces, an objective with two observation beam paths and at least one illumination beam path. The illumination beam path preferably extends on the side opposite from the eyepieces. A reflecting component is provided which deflects the illumination beam path in such a way that it passes through the objective preferably parallel to the observation beam paths.

According to the invention, this illumination, coming from the back, is deflected by illumination optics vertically downward into an objective between, in front of, or after the channels of the observation zoom, wherein the optical axes of the deflected illumination beam path and of the channels of the observation zoom are approximately parallel in the space between the illumination deflecting element, the optics at the entrance of the observation zoom and the objective. In order to adapt the size of the illuminated image field to the scale ratios of the observation zoom with the objective, the illumination optics are constructed, according to the invention, as an illumination zoom—hereinafter referred to as light zoom. The movements of the light zoom and observation zoom are coupled with one another so as to advantageously correspond to the scale ratios. Accordingly, the light spot imaged by the light zoom is circular and always lies in the focused plane of the microscope objective.

According to a preferred embodiment form of the present invention, the fluorescence illumination and the stereo microscope observation channels are integrated in an incident light fluorescence stereo microscope body. The illumination according to the invention includes a light staircase, a light protection shutter, a light zoom and a stationary deflecting element. The illumination beam path is guided via the light staircase into the light zoom which images the light spot, corresponding to the respective magnifications adjusted in the observation channels, in the object plane by the deflecting element through the excitation filter and the objective. The objective, two blocking filters and the optics in the observation channels are associated with the stereoscopic observation beam path. The fluorescing object is imaged through the objective, two blocking filters and the optics in the observation channels for observation in the microscope tube. A suitable coupling between the light zoom and the observation zoom causes the scale ratios in the light zoom to be adapted corresponding to the scale ratios in the illumination zoom. Excitation filters and blocking filters are advantageously mounted in modules. The modules themselves are outfitted with various filter combinations or must be equipped individually and can therefore be exchanged, changed or switched quickly. The light protection shutter automatically covers the illumination beam path when exchanging, changing or switching the modules.

In this connection, it is advantageous when the incident illumination for fluorescence excitation is deflected coming from behind vertical to the optical axes of the observation beam paths by a deflecting element which has a cemented convex lens and which is arranged at the height of the front lenses of the observation zoom in front of the optical axes of the observation beam paths toward the objective in such a way that the illumination beam path is coaxial and parallel to the observation beam paths in the space between the front lens, observation zoom, deflecting element and objective.

In a preferred solution, the illumination beam path and the observation beam paths pass through the objective in a circle diameter containing the maximum effective (free) diameter of the observation systems and illumination system. The objective diameter is greater than this circle diameter containing the maximum effective (free) diameter of the observation systems and illumination system. The plane defined by the observation beam paths has a parallel offset relative to a meridian plane of the optical axis of the objective.

According to the invention, the illumination with a fluorescence light source is guided via the illumination beam path. At least one blocking filter for short-wave light beams is arranged in the observation beam path and an exciter filter for limiting the bandwidth of the fluorescence light is arranged in each illumination beam path. The blocking filter and exciter filter lie in a plane and are mounted in a common filter holder. A filter wheel having receptacles for three exchangeable filter holders with different combinations of blocking and exciter filters which can be switched into the channels of the observation beam paths and illumination beam path alternately by rotating the filter wheel is arranged in the space between the front lens, observation zoom, deflecting element and objective. The filter wheel itself can also be exchanged for another filter wheel. A filter carrier without a blocking filter and exciter filter or with attenuation filters instead of the blocking filter and a UV filter instead of the exciter filter is provided for normal illumination without fluorescence excitation.

According to the invention, the observation zoom and the illumination zoom are coupled with one another or also selectively adjusted by two drives, respectively, preferably spindle drives. As is described in DE 198 222 56, the disclosure of which is hereby adopted herein in its entirety by reference, the spindle drives for the observation zoom and for the light zoom are synchronously controlled in a stepwise manner by an electronic control unit working with application-specific software corresponding to the respective linear or optionally nonlinear paths in such a way that the illumination in the illumination beam path is correspondingly adapted to the size ratios and aperture ratios in the object plane in the coupled mode when changing the magnification in the observation beam path.

The solution, according to the invention, of an incident light fluorescence stereo microscope body is particularly advantageous for the user because the coaxial incident light fluorescence excitation is carried out with a high illumination aperture for all observation zoom magnifications and, because of the coupling of the light zoom and observation zoom, the size of the sharply defined circular image field, which is illuminated in a sufficiently homogeneous manner, is always adapted to the scale ratios of the observation zoom with objective and lies in the focused object plane. It is advantageous when the optics of the light zoom have a high light-transmitting value and are optimized for a sufficiently high transparency for UV and blue light so that a high illumination intensity can be achieved in the object plane. Another advantage consists in that the excitation filters and blocking filters arranged in the space between the illumination deflecting element, the optics at the entrance of the observation zoom and the objective which is suitable for fluorescence can be quickly changed, exchanged and covered.

### BRIEF DESCRIPTION OF THE DRAWINGS

In the drawings:

FIGS. 1-6 represent the art in perspective view;

Preferred embodiment examples of the incident light fluorescence stereo microscope body, according to the invention, with integrated fluorescence illumination and stereo microscope observation channels are described more fully with reference to the drawings in FIGS. 7 to 14.

FIG. 7 is an optical diagram of the incident light fluorescence stereo microscope body;

FIG. 8 is an optical diagram of the incident light fluorescence stereo microscope body with the coupled optics component groups;

FIG. 9 shows the optics component groups with the corresponding adjusting elements and their control unit;

FIG. 10 shows the construction and possible use of the fluorescence modules in a filter wheel and with the filter wheel in the incident light fluorescence stereo microscope body;

FIG. 11 shows the principle for mounting the filter wheel in the incident light fluorescence stereo microscope body;

FIG. 12 shows the arrangement of the loaded filter wheel in the incident light fluorescence stereo microscope body between the deflecting element with convex lens of the illumination beam path, the first lens group of the observation beam path and the objective;

FIG. 13 shows the illumination of the object field to be observed with spot illumination/excitation; and

FIG. 14 shows the arrangement, construction and operating dynamics of the zoom optics in the observation beam paths and in the illumination beam path.

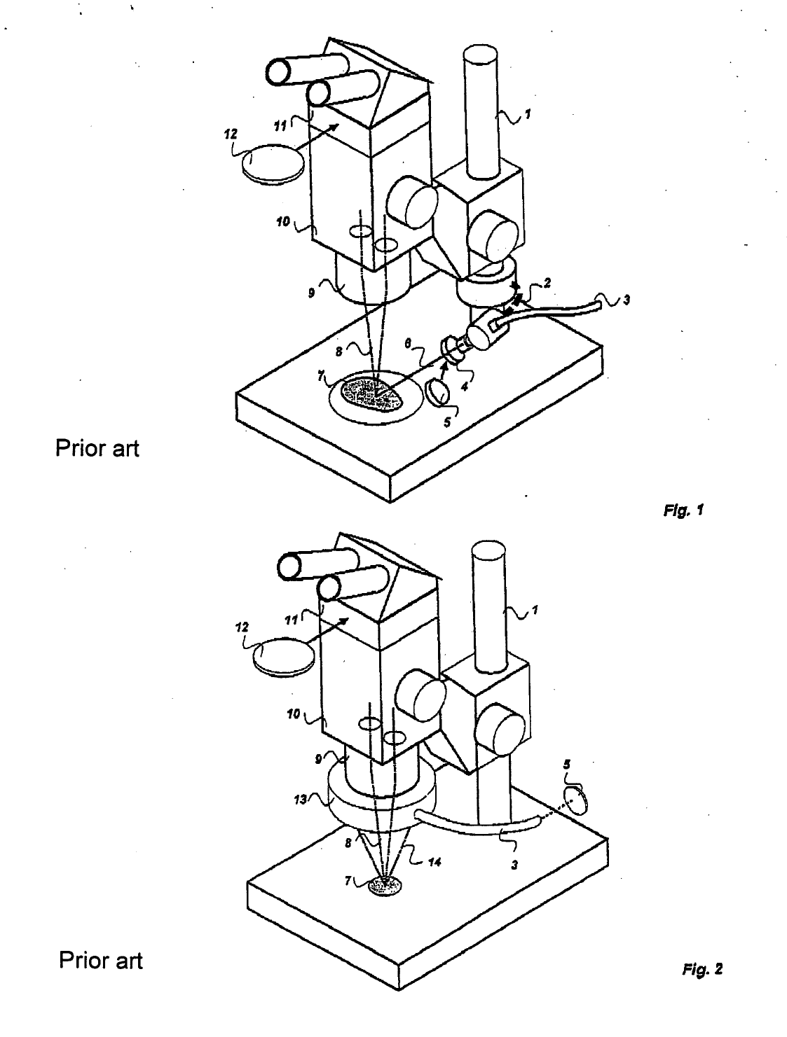

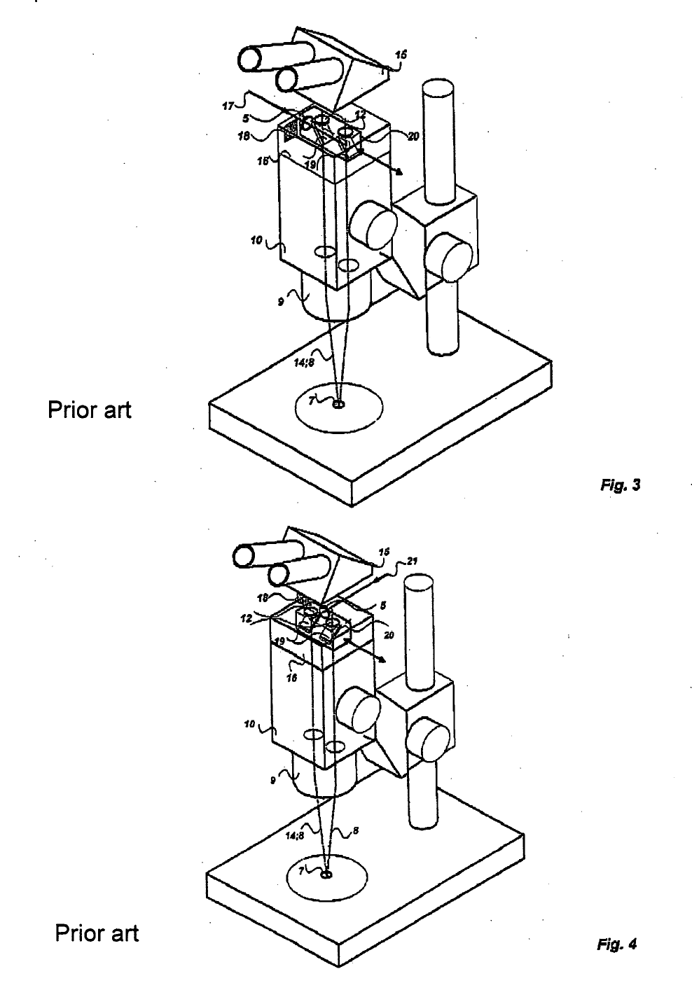

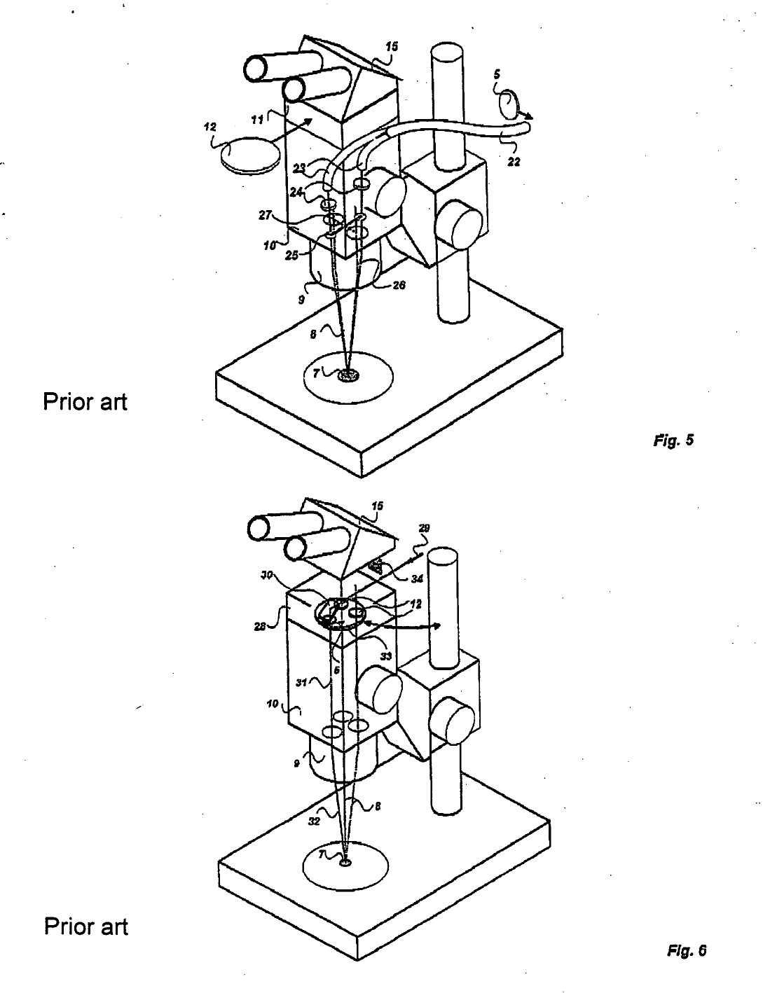

### DESCRIPTION OF THE PREFERRED EMBODIMENTS

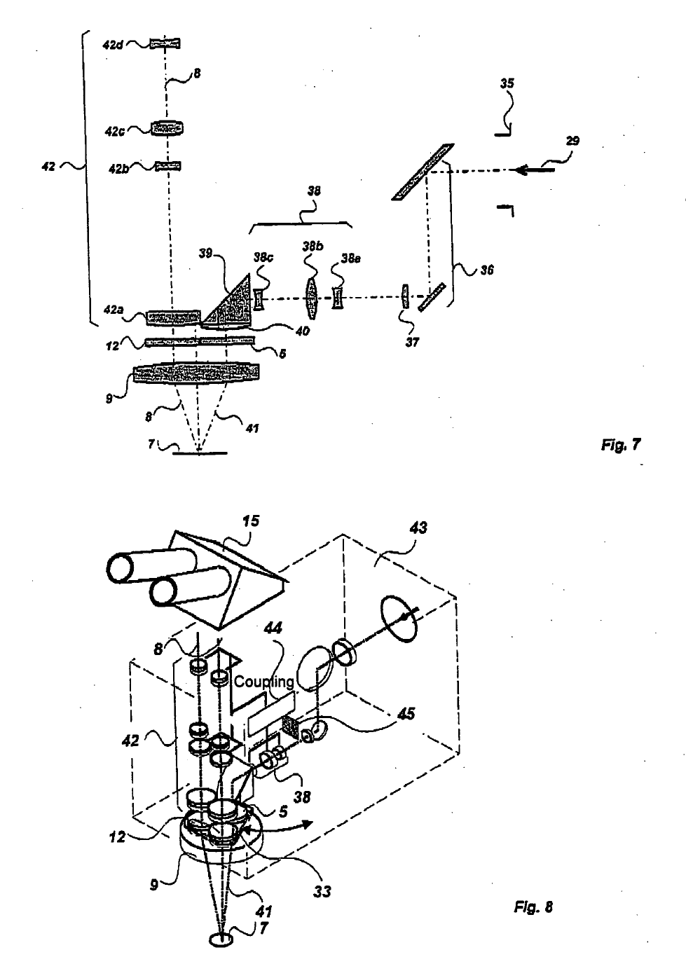

According to FIG. 7 and FIG. 8, the illumination light 29 entering from the light attachment 35 of the incident light fluorescence stereo microscope body 43 is deflected through the excitation filter 5 via a light staircase 36, an illumination lens 37, a light zoom 38, and a stationary deflecting element 39 with a convex lens 40 fitted to it and is then guided as excitation beam path 41 through the objective 9 at an inclination approaching the stereo angle from the back toward the circular light spot 7 in the object plane. The stereoscopic observation beam path 8 proceeding from the fluorescing object travels back via the objective 9 through two blocking filters 12 into the observation zoom 42 of the incident light fluorescence stereo microscope body 43 and continues to the observing tube 15. The light zoom 38 is connected to the observation zoom 42 by a suitable coupling element 44 in such a way that the illumination ratios in the excitation beam path 41 are correspondingly adapted when changing the magnification in the observation zoom 42. The excitation filter 5 and blocking filter 12 are mounted in the filter modules 33 which are equipped depending on the fluorescence analysis method and can be changed or switched in the incident light fluorescence stereo microscope body 43. When changing the fluorescence modules, the illumination light 29 is covered by a shutter 45 that switches on automatically.

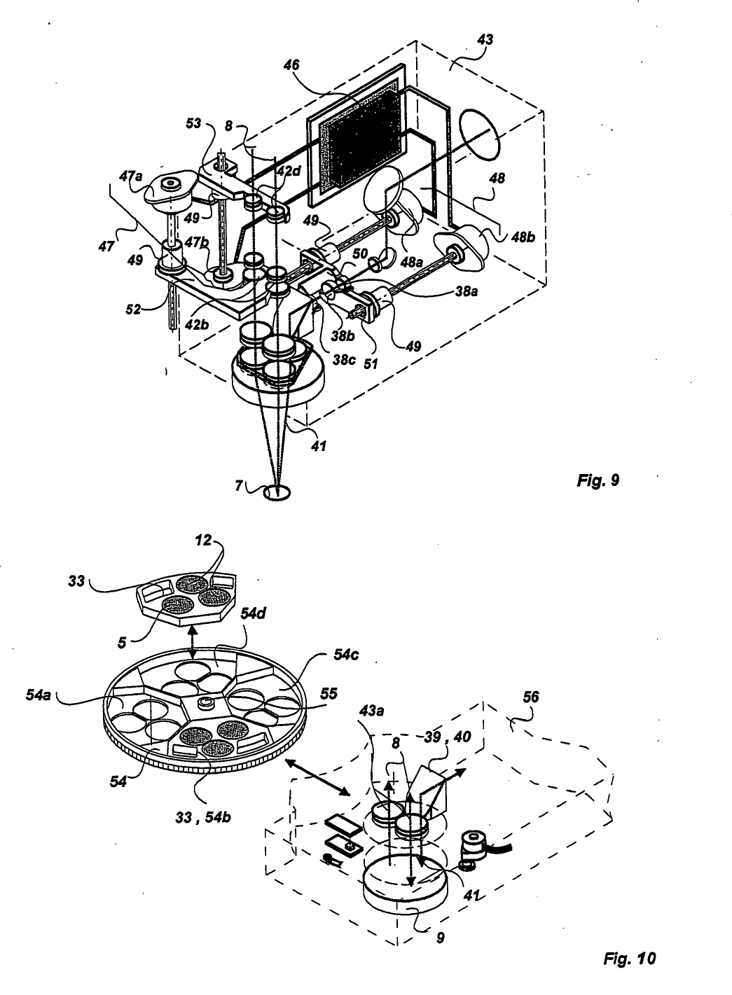

According to FIG. 9, the suitable coupling element 44 arranged in the incident light fluorescence stereo microscope body 43 is an electronic control unit 46 which synchronously controls four spindle drives 47a, 47b, 48a and 48b corresponding to the respective linear or optionally nonlinear paths in a stepwise manner. Two spindle drives 48 act on the light zoom 38 and two spindle drives 47 act on the observation zoom 42. Spindle drive 48a adjusts the carriage 50 with the two illumination lenses 38a and 48a by means of the spindle nut 49 and spindle drive 48b adjusts the carriage 51 with an illumination lens 38b by means of spindle nut 49. Spindle drive 47a adjusts the carriage 52 with the first adjustable lens group 42b of the observation zoom 42 by means of spindle nut 49, and spindle drive 47b adjusts the carriage 53 with the second adjustable lens group 42d of the observation zoom 42 by means of spindle nut 49. The electronic control unit 46 controls the spindle drives of the light zoom 38 and observation zoom 42 jointly. If required, the coupling of the light zoom and observation zoom is detachable for individual adjustment of the two zoom systems.

According to FIG. 10, the filter modules 33, each of which is equipped with an excitation filter 5 and two blocking filters 12 depending on the fluorescence analysis method, can be inserted and changed in four module holders 54a, 54b, 54c and 54d of the filter wheel 54. The filter wheel itself can be inserted and changed in the filter wheel holder 56 of the incident light fluorescence stereo microscope body in the space between the deflecting element 39 with convex lens 40, the first lens group 42a and the objective 9.

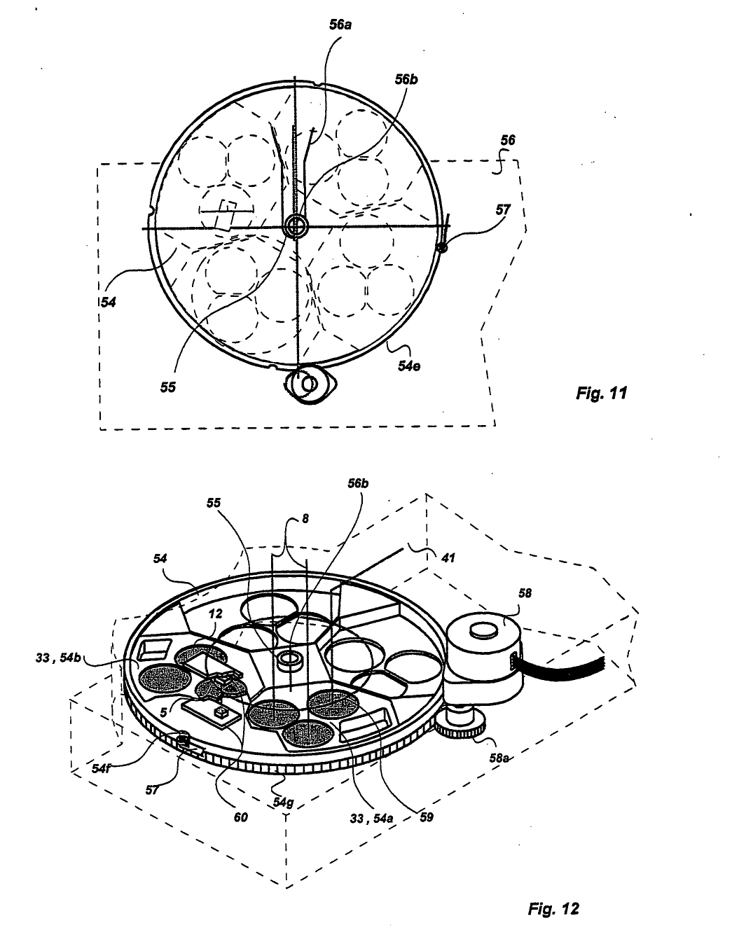

In FIG. 11, the center axis of the guide groove 56a for inserting the filter wheel 54 with its bearing pin 55 in the filter wheel holder 56 is slightly offset laterally relative to the center axis of the pivot bearing 56b at the end of the guide groove. The width of the guide groove 56a and the pivot bearing 56b at the end of the guide groove correspond to the diameter of the bearing pin 55 of the filter wheel. When the filter wheel is inserted, the pressing spring 57 presses against the diameter 54e of the filter wheel and the occurring counterforce must be overcome.

In FIG. 12, the stop is reached and the above-mentioned counterforce is overcome. The pressing spring 57 has pressed the bearing pin 55 in the pivot bearing 56b and, after a slight rotation of the filter wheel 54, the pressing spring 57 itself catches in one of the four function positions 54f for the filter modules 33. The filter wheel 54 accordingly locks in the pivot bearing and in the four function positions 54f for the filter modules 33 by means of the pressing spring 57. In the locked state, the toothing 54g of the filter wheel 54 formed as a gripping element engages without play in the pinion 58a of the drive motor 58. The filter wheel can be rotated forward or backward by motor or manually while securely locked. In addition, an electrooptical transmitter-receiver system for color detection 60 is arranged over the path 59 described by the excitation filter and the internal blocking filter when the filter wheel 54 is rotated. The above-mentioned filters are measured individually in succession by means of the electrooptical transmitter-receiver system when switching between the filter modules by motor or manually and the filter parameters of the filter combination being used are automatically determined therefrom and the light protection shutter 45 is indirectly controlled along with it in the illumination beam path when switching or changing.

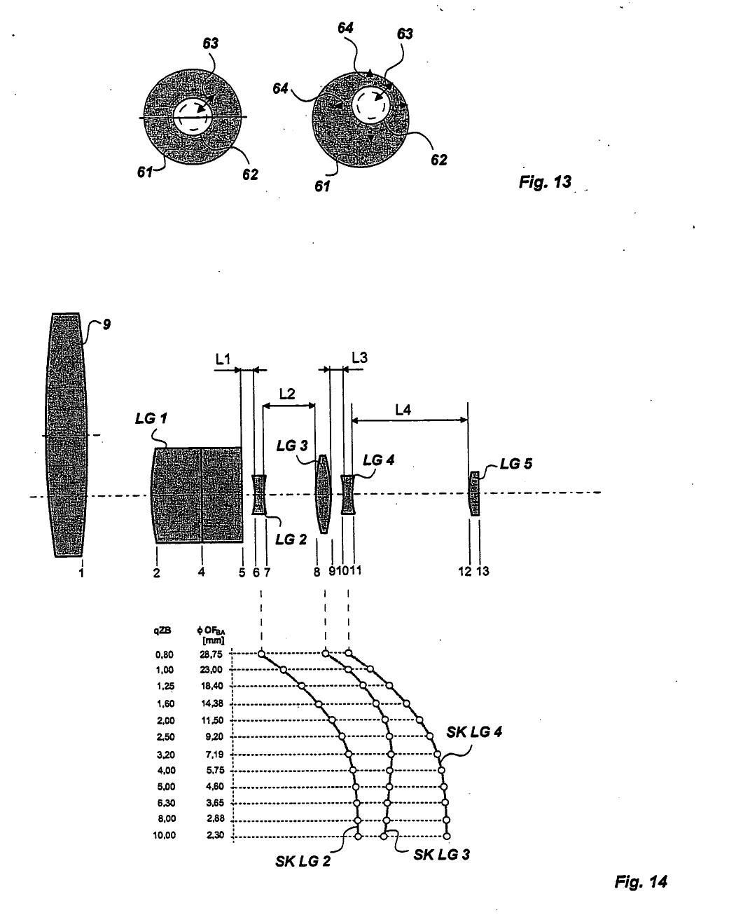

In FIG. 13, the object field to be observed is designated by 61, the light field which does not completely illuminate the object field with spot illumination or spot excitation is designated by 62, the size variation of the illuminating spot 62 is designated by 63, and the position displacement of the illuminating spot 62 in the object field 61 to be observed is designated by 64.

In FIG. 14, in addition to the reference numbers in the observation beam path indicated in the preceding Figures, A, designates the measurement of the distance from the objective to the entrance surface of the first zoom lens group, Bᵥ designates the measurement of the distance from the objective to the entrance surface of the second zoom lens group, Cᵥ designates the measurement of the distance from the objective to the entrance surface of the third zoom lens group, and Dᵥ designates the measurement of the distance from the objective to the entrance surface of the fourth zoom lens group.

In the illumination beam path, A_{L} designates the measurement of the distance from the objective to the light outlet surface of the deflecting prism with lens, B_{L} designates the measurement of the distance from the objective to the light outlet surface of the first zoom lens, C_{L} designates the measurement of the distance from the objective to the light outlet surface of the second zoom lens, D_{L} designates the measurement of the distance from the objective to the light outlet surface of the third zoom lens, and E_{L} designates the measurement of the distance from the objective to the light outlet surface of the fourth zoom lens. The diagram shows the movement dynamics of the zoom systems in the observation beam path and illumination beam path as a function of microscope magnification.

A preferred embodiment example for the zoom system in the illumination beam path is shown in the following table:

| Surface | Radius | Distance | | |
|---|---|---|---|---|
| Number | [mm] | [mm] | nₑ | νₑ |
| 1 | | 18.00 | | |
| 2 | 37.047 | 14.50 | 1.51872 | 63.96 |
| 3 | ∞ | 12.00 | 1.51872 | 63.96 |
| 4 | ∞ | | | |
| | | L1 32.00 L 3.04 | | |
| 5 | −8.058 | 2.50 | | |
| 6 | 25.30 | | 1.58482 | 40.57 |
| | | L2 4.21 L 15.50 | | |
| 7 | 16.55 | 4.40 | 1.48914 | 70.23 |
| 8 | −16.55 | | | |
| | | L3 14.72 L 3.43 | | |
| 9 | −20.54 | 250 | 1.58482 | 40.57 |
| 10 | ∞ | | | |
| | | L4 2.17 L 31.13 | | |
| 11 | 47.66 | 3.00 | 1.48914 | 70.23 |
| 12 | ∞ | | | |

Surface number 1 is assigned to the objective exit surface, surface numbers 2 to 5 are assigned to the first lens group (LG 1), surface numbers 6 and 7 are assigned to the second lens group (LG 2), surface numbers 8 and 9 are assigned to the third lens group (LG #), surface numbers 10 and 11 are assigned to the fourth lens group (LG 4) and surface numbers 12 and 13 are assigned to the fifth lens group (LG 5). During the zoom movement, the prism entrance surface (surface number 2) is the aperture diaphragm of the illumination beam path with zoom magnifications in the observation beam path of 4×-10×, the movable collecting lens (surface number 7) is the aperture diaphragm of the illumination beam path with zoom magnifications in the observation beam path of 0.8×-4×.

The surface numbers of a lens or lens component, the radius of curvature of the respective surface, the distance to the next surface, the index of refraction (ne) and the dispersion (Abbe number ve=(ne−1)/(nF′−nC′)) are listed in the columns of the table. An air gap is represented by an empty row in the material parameters and L1, L2, L3 and L4 designate the variable distances between the lenses or lens groups of the zoom system.

When the observation zoom is coupled with the light zoom, the distances L1, L2, L3 and L4 are specified in the following table depending on the zoom magnification in the observation beam path qZB, wherein the size of the observed and illuminated object field diameter Ø OFBA and the distances L1, L2, L3 and L4 are associated with the zoom magnification in the observation beam path qZB:

| Zoom | | | | | |
|---|---|---|---|---|---|
| magni- | | | | | |
| fication | Object | | | | |
| in the | field | | | | |
| observation | diameter | Distance | Distance | Distance | Distance |
| beam | Ø OFBA | L1 | L2 | L3 | L4 |
| path qZB [x] | [mm] | [mm] | [mm] | [mm] | [mm] |
| 10.00 | 2.30 | 32.004 | 4.214 | 14.717 | 2.171 |
| 8.00 | 2.88 | 32.176 | 4.663 | 14.268 | 2.000 |
| 6.30 | 3.65 | 31.798 | 5.417 | 13.514 | 2.377 |
| 5.00 | 4.60 | 31.323 | 6.311 | 12.619 | 2.847 |
| 4.00 | 5.75 | 30.948 | 7.157 | 11.774 | 3.227 |
| 3.20 | 7.19 | 29.476 | 8.680 | 10.251 | 4.700 |
| 2.50 | 9.20 | 27.715 | 10.316 | 8.614 | 6.460 |
| 2.00 | 11.50 | 24.520 | 12.170 | 6.761 | 9.656 |
| 1.60 | 14.38 | 20.690 | 13.643 | 5.287 | 13.486 |
| 1.25 | 18.40 | 16.114 | 14.537 | 4.394 | 18.065 |
| 1.00 | 23.00 | 10.773 | 15.678 | 3.227 | 23.402 |
| 0.80 | 28.75 | 3.043 | 15.499 | 3.432 | 31.133 |

The zoom magnification in the observation beam path (qZ), the size of the object field diameter (Ø OFBA) observed and illuminated as a function of the zoom magnification, and the variable distances L1, L2, L3 and L4 between the lenses or lens groups are listed in the columns of the table.

The invention is not limited to the embodiment examples shown herein. Further developments in the art do not lead to a departure from the protective scope of the claims

While the foregoing description and drawings represent the present invention, it will be obvious to those skilled in the art that various changes may be made therein without departing from the true spirit and scope of the present invention.

Reference Numbers

1 pillar
2 cantilever holder
3 lightguide
4 focusing attachment
5 excitation filter
6,26,41 excitation beam path
7 light spot in the object plane
8 stereoscopic observation beam path
9 objective
10 stereo microscope body
11 filter intermediate tube
12 blocking filter
13 ring lamp
14,32 excitation light
15 observing tube
16,28 fluorescence illuminator
17,21,29 illumination light
18,34,45 shutter
19 dichroic mirror
20 slide module
22 twin lightguide
23 individual fiber bundle
24 focusing optics
25 illumination plane
27 observation plane
30 mirror
31 illumination channel
33 filter module
35 light attachment
36 illumination lens
37 light staircase
38 light zoom
38a,38b,38c illumination lenses, light zoom
39 deflecting element
40 convex lens
42 observation zoom
42a,42d lens groups, observation zoom
43 incident light fluorescence stereo microscope body
44 coupling element
46 electronic control unit
47 spindle drives, observation zoom 42
47a spindle drive of first adjustable lens group 42b
47b spindle drive of second adjustable lens group 42d
48 spindle drives, light zoom 38
48a spindle drive for illumination lenses 38a and 38c
48b spindle drive for illumination lens 38b
49 spindle nut
50 carriage, illumination lenses 38a and 38c
51 carriage, illumination lens 38b
52 carriage of first adjustable lens group 42b
53 carriage of second adjustable lens group 42d
54 filter wheel
54a-54d module holders
54e diameter of the filter wheel
54f function positions
54g toothing
55 bearing pin
56 filter wheel holder
56a guide groove
56b pivot bearing
57 pressing spring
58 drive motor
58a pinion
59 path of excitation filter and internal blocking filter under 60
60 electrooptical transmitter-receiver system
61 observed object field
62 light field with spot illumination/spot excitation
63 size variation of illuminating spot
64 position displacement of illuminating spot
LG 1 first optical lens group of the light zoom
LG 2 second optical lens group of the light zoom
LG 3 third optical lens group of the light zoom
LG 4 fourth optical lens group of the light zoom
LG 5 fifth optical lens group of the light zoom
Ep_{L} entrance pupil of the light zoom
q_{ZL} zoom magnification in the light zoom
q_{ZB} zoom magnification in the observation beam path
q_{Z} zoom factor of the light zoom =maximum zoom magnification/minimum zoom magnification
ØOF_{BA} observed and illuminated object field diameter
L1 distance between first and second optical lens group
L2 distance between second and third optical lens group
L3 distance between third and fourth optical lens group
L4 distance between fourth and fifth optical lens group

1. An incident light fluorescence stereo microscope comprising:
two eyepieces;
an objective with two observation beam paths;
at least one illumination beam path, wherein the illumination beam path preferably extends on the side opposite from the eyepieces; and
a reflecting component being provided which deflects the illumination beam path in such a way that it passes through the objective preferably parallel to the observation beam paths.

2. The incident light fluorescence stereo microscope according to claim 1, wherein a first zoom device is provided for the observation beam paths and a second zoom device is provided for the illumination beam path.

3. The incident light fluorescence stereo microscope according to claim 2, wherein the first zoom device and second zoom device are in a working connection with one another, wherein an adjustment of the first zoom device preferably causes a matching change in the second zoom device.

4. The incident light fluorescence stereo microscope according to claim 2, wherein the first and second zoom devices have drive motors which can be controlled separately or jointly.

5. The incident light fluorescence stereo microscope according to claim 4, wherein the drive motors are controlled by a programmable electronic controller.

6. The incident light fluorescence stereo microscope according to claim 1, wherein a filter holder is provided which has excitation filters for the illumination beam path and emission filters for the observation beam paths, wherein the filter holder can preferably be arranged in the area of the stereo microscope in which the illumination beam path and observation beam paths are substantially parallel.

7. The incident light fluorescence stereo microscope according to claim 6, wherein a filter changer is provided which can receive a plurality of filter holders and which makes it possible to change quickly between different filter holders.

8. The incident light fluorescence stereo microscope according to claim 6, wherein the filter holder or the filter changer is exchangeable.

9. The incident light fluorescence stereo microscope according to claim 6, wherein a shutter is provided in the observation beam paths or in the illumination beam path, which shutter interrupts the beam path when changing the filters and accordingly prevents illumination light from reaching the eyepiece.

10. The incident light fluorescence stereo microscope according to claim 4, wherein the drive motors for the illumination beam path are controllable in such a way that only a portion of the observation beam path is illuminated.

11. The incident light fluorescence stereo microscope according to claim 10, wherein means are provided for controlling the orientation of the illumination beam path that only partly illuminates the observation beam path.

12. The incident light fluorescence stereo microscope according to claim 1, wherein means are provided for interrupting and/or attenuating the illumination beam path.

13. The incident light fluorescence stereo microscope according to claim 6, wherein a device for determining the filter characteristics is provided in the vicinity of the filter holder.

14. The incident light fluorescence stereo microscope according to claim 13, wherein a device is provided for displaying the filter characteristics.

15. The incident light fluorescence stereo microscope according to claim 1, wherein illumination optics in the illumination beam path contain a first, second, third, fourth and fifth lens group with positive, negative, positive, negative and positive refractive power in that order considered from the side of the objective and in which the second lens group can be moved with the fourth lens group and the third lens group as light zoom optics in the direction of the optical axes for changing focal length, while the first lens group and fifth lens group remain in a fixed position.

16. The incident light fluorescence stereo microscope according to claim 15, wherein the lens arrangement in the illumination beam path considered from the side of the objective is specified in the following table, wherein surface number 1 is assigned to the objective exit surface, surface numbers 2 to 5 are assigned to the first lens group (LG 1), surface numbers 6 and 7 are assigned to the second lens group (LG 2), surface numbers 8 and 9 are assigned to the third lens group (LG 3), surface numbers 10 and 11 are assigned to the fourth lens group (LG 4) and surface numbers 12 and 13 are assigned to the fifth lens group (LG 5), and wherein, during the zoom movement, the prism entrance surface (surface number 2) is the aperture diaphragm of the illumination beam path with zoom magnifications in the observation beam path of 4×-10× and the movable collecting lens (surface number 7) is the aperture diaphragm of the illumination beam path with zoom magnifications in the observation beam path of 0.8×-4×:

| Surface | Radius | Distance | | |
|---|---|---|---|---|
| Number | [mm] | [mm] | nₑ | νₑ |
| 1 | | 18.00 | | |
| 2 | 37.047 | 14.50 | 1.51872 | 63.96 |
| 3 | ∞ | 12.00 | 1.51872 | 63.96 |
| | | L1 32.00 L 3.04 | | |
| 4 | ∞ | | | |
| 5 | −8.058 | 2.50 | | |
| 6 | 25.30 | | 1.58482 | 40.57 |
| | | L2 4.21 L 15.50 | | |
| 7 | 16.55 | 4.40 | 1.48914 | 70.23 |
| 8 | −16.55 | | | |
| | | L3 14.72 L 3.43 | | |
| 9 | −20.54 | 250 | 1.58482 | 40.57 |
| 10 | ∞ | | | |
| | | L4 2.17 L 31.13 | | |
| 11 | 47.66 | 3.00 | 1.48914 | 70.23 |
| 12 | ∞ | | | |

wherein the surface numbers of a lens or lens component, the radius of curvature of the respective surface, the distance to the next surface, the index of refraction (ne) and the dispersion (Abbe number ve=(ne−1)/(nF′−nC′)) are listed in the columns of the table, and wherein air gap is represented by an empty row in the material parameters and L1, L2, L3 and L4 designate variable distances.

17. The incident light fluorescence stereo microscope according to claim 15, wherein when the observation zoom is coupled with the light zoom, the distances L1, L2, L3 and L4 are specified in the following table depending on the zoom magnification in the observation beam path qZB, wherein the size of the observed and illuminated object field diameter Ø OFBA and the distances L1, L2, L3 and L4 are associated with the zoom magnification in the observation beam path qZB:

| Zoom | | | | | |
|---|---|---|---|---|---|
| magni- | | | | | |
| fication | Object | | | | |
| in the | field | | | | |
| observation | diameter | Distance | Distance | Distance | Distance |
| beam | Ø OFBA | L1 | L2 | L3 | L4 |
| path qZB [x] | [mm] | [mm] | [mm] | [mm] | [mm] |
| 10.00 | 2.30 | 32.004 | 4.214 | 14.717 | 2.171 |
| 8.00 | 2.88 | 32.176 | 4.663 | 14.268 | 2.000 |
| 6.30 | 3.65 | 31.798 | 5.417 | 13.514 | 2.377 |
| 5.00 | 4.60 | 31.323 | 6.311 | 12.619 | 2.847 |
| 4.00 | 5.75 | 30.948 | 7.157 | 11.774 | 3.227 |
| 3.20 | 7.19 | 29.476 | 8.680 | 10.251 | 4.700 |
| 2.50 | 9.20 | 27.715 | 10.316 | 8.614 | 6.460 |
| 2.00 | 11.50 | 24.520 | 12.170 | 6.761 | 9.656 |
| 1.60 | 14.38 | 20.690 | 13.643 | 5.287 | 13.486 |
| 1.25 | 18.40 | 16.114 | 14.537 | 4.394 | 18.065 |
| 1.00 | 23.00 | 10.773 | 15.678 | 3.227 | 23.402 |
| 0.80 | 28.75 | 3.043 | 15.499 | 3.432 | 31.133 |
